(19) United States
(12) Patent Application Publication
(10) Pub. No.: US 2026/0340410 A1
(43) Pub. Date: Oct. 29, 2026

(54) METHODS AND APPARATUS TO PERFORM MANY-TO-ONE FEATURE DISTILLATION IN NEURAL NETWORKS

(71) Applicant: Intel Corporation, Santa Clara, CA (US)

(72) Inventors: Xiaolong Liu, Beijing (CN); Anbang Yao, Beijing (CN); Chao Li, Beijing (CN); Yurong Chen, Beijing (CN)

(73) Assignee: Intel Corporation, Santa Clara, CA (US)

(21) Appl. No.: 19/123,388

(22) PCT Filed: Nov. 22, 2022
(86) PCT No.: PCT/CN2022/133490

§ 371 Date: Apr. 22, 2025

(51) Int. Cl. G06N 3/096

(52) U.S. Cl. CPC G06N 3/096

(57) ABSTRACT

Methods, apparatus, systems, and articles of manufacture are disclosed to train a teacher network and a student network simultaneously without a pre-trained teacher model. A n apparatus comprising at least one memory, machine readable instructions, and processor circuitry to at least one of instantiate or execute the machine readable instructions to generate a first feature map for a teacher network based a query, the first feature map having a first channel dimension, generate a second feature map for a student network based on the query, the second feature map having a second channel dimension, the second channel dimension different than the first channel dimension, split the second feature map into segments having the first channel dimension, train the teacher network using the segments of the second feature map, and train the student network by applying a total loss value to the student network, the total loss value based on a loss function, wherein the teacher network and the student network are trained on an edge device.

### FIELD OF THE DISCLOSURE

This disclosure relates generally to neural networks and, more particularly, to methods and apparatus to perform many-to-one feature distillation in neural networks.

### BACKGROUND

Neural networks are a subset of machine learning and are at the heart of deep learning algorithms. Neural networks take input data and generate an output based on an analysis of the input data using a training model to generate the best (e.g., most accurate) answer to a given input. Training models are constantly re-trained to generate more accurate answers and to optimize the neural network.

### BRIEF DESCRIPTION OF THE DRAWINGS

FIG. 1 is a schematic illustration of a knowledge distillation architecture.

FIG. 2 is a block diagram of the example knowledge distillation circuitry of FIG. 1.

FIG. 3 is a block diagram of the example teacher training circuitry and student training circuitry of FIG. 2.

FIG. 4 is an operational illustration of the knowledge distillation architecture of FIG. 1.

FIG. 5 is a flowchart representative of example machine readable instructions and/or example operations that may be executed by example processor circuitry to implement the knowledge distillation architecture of FIG. 1.

FIG. 6 is a flowchart representative of example machine readable instructions and/or example operations that may be executed by example processor circuitry to perform the knowledge distillation of FIG. 5.

FIG. 7 is a flowchart representative of example machine readable instructions and/or example operations that may be executed by example processor circuitry to implement the training of the teacher and student networks of FIG. 6.

FIG. 8 is a flowchart representative of example machine readable instructions and/or example operations that may be executed by example processor circuitry to generate the total loss value of FIG. 6.

FIG. 9 is a block diagram of an example processing platform including processor circuitry structured to execute the example machine readable instructions and/or the example operations of FIG. 3 to implement the knowledge distillation circuitry of FIG. 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 5, 6, 7, and/or 8) to client devices associated with end users and/or consumers (e.g., for license, sale, and/or use), retailers (e.g., for sale, re-sale, license, and/or sub-license), and/or original equipment manufacturers (OEM s) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Neural networks implementing knowledge distillation typically train a student network based upon a pre-trained teacher network. Feature maps of the teacher network are created to be used as knowledge points for the student network to learn. This methodology is known as two-step knowledge distillation. Alternatively, some neural networks utilize an online training framework which does not require pre-training the teacher model. This methodology is known as one-stage knowledge distillation.

Knowledge distillation typically require a pre-trained teacher network to be able to train a student network. The teacher network is typically trained with a machine exhibiting high amounts of computing resources and/or capabilities (e.g., high-end CPUs, GPUs, RAM, etc.). Such computing resources are not typically implemented local devices (e.g., edge devices, user devices, etc.) because of the computing power required to train the teacher network.

Since student networks are usually housed on an edge device and do not have the capability to train the teacher network, the student network must thus rely on the pre-trained teacher network to teach the student network. This is undesirable for edge devices since they must retrieve data from feature maps on the teacher network to determine an output (e.g., an answer to a question, a result, etc.) and the neural network must pre-train the teacher model before the student network can be trained.

To train the student network, neural networks create feature maps from the teacher network and transform modules are created to adapt the feature maps to the student network. Once the teacher is trained, the transform modules are abandoned and each feature from the feature map is matched in a one-to-one representation to the student network. Latency in neural networks is increased due to this process because of the steps required to train the teacher network and create the one-to-one representations. Such a process is known as two-step knowledge distillation.

Alternatively, in one-step knowledge distillation, neural networks retrieve data from an online teacher network, which is a network without any training. Since the neural network does not train the teacher model itself, computing power requirements are reduced at the edge device level, but latency is still increased due to requiring data (e.g., feature maps, feature representations, etc.) to be retrieved from online sources (e.g., sources which are external to the device performing the training of the student network). Additionally, these processes still utilize a one-to-one representation of the features in the feature map on the teacher network and are less accurate than two-step knowledge distillation since the neural network does not train the teacher network.

Therefore, there exists a need for an online knowledge distillation process (e.g., one-step knowledge distillation) that trains the teacher network and the student network simultaneously while reducing computation power requirements at the edge device level and reduces latency while increasing accuracy.

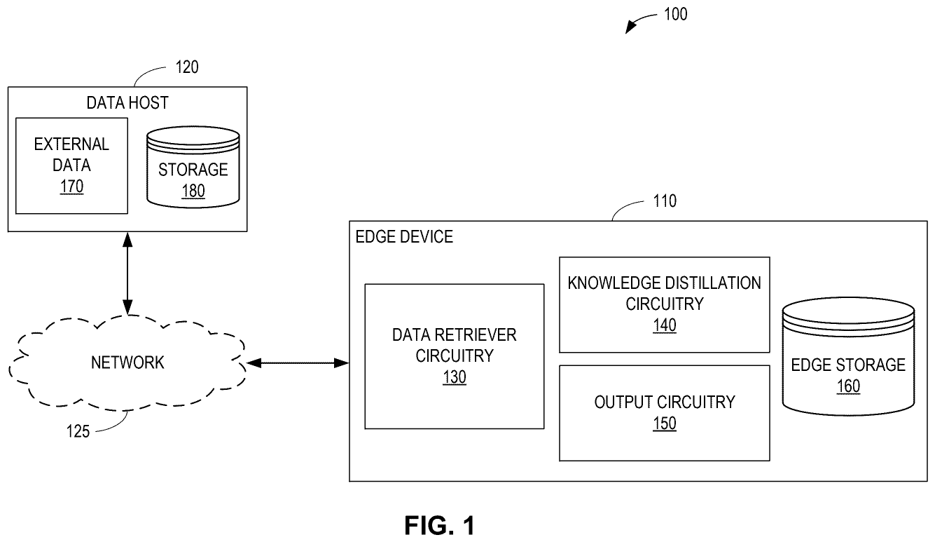

FIG. 1 is a schematic illustration of a knowledge distillation architecture 100. The knowledge distillation architecture 100 of the illustrated example of FIG. 1 includes an edge device 110 and a data host 120. In some examples, the edge device 110 accesses data from the data host 120 via a network 125. In other examples, the edge device 110 accesses the data from the data host 120 by direct communication with the data host 120 (e.g., Ethernet, Universal Serial Bus (USB), Peripheral Component Interconnect (PCI), etc.)

The edge device 110 includes a data retriever circuitry 130, a knowledge distillation circuitry 140, and an output circuitry 150. In some examples, the edge device 110 includes an edge storage 160 to store data onto the edge device 110 directly.

The data retriever circuitry 130 communicates with the data host 120 to retrieve data to train a teacher and student network (e.g., a teacher network 410 and a student network 420). In some examples, the data retriever circuitry 130 communicates with the data host 120 via the network 125. In other examples, the data retriever circuitry 130 accesses data directly from the data host 120. In some examples, the data retriever circuitry 130 establishes a data source prior to retrieving the data. In such an example, the data retriever circuitry 130 determines whether to retrieve data from the data host 120 via the network 125 (e.g., to retrieve data from online sources, big data sources, etc.) or to retrieve data from local storage devices (e.g., a storage 180 on the data host 120).

The knowledge distillation circuitry 140 performs a knowledge distillation process to train the teacher network 410 and the student network 420 from the data retrieved from the data retriever circuitry 130. In the examples described herein, the knowledge distillation circuitry 140 communicates with the data retriever circuitry 130. However, the edge device 110 could omit the data retriever circuitry 130 and the knowledge distillation circuitry 140 can communicate directly with the data host 120.

The output circuitry 150 outputs a result of the trained teacher and student networks 410, 420. In some examples, the result could include an answer to a query (such as a natural language answer), an image, an audio clip, a command, etc. In some examples, the output circuitry 150 communicates the result to the data host 120 via the network 125. In other examples, the output circuitry 150 stores the result to the data host 120 by communicating with the data host 120 directly. In some examples, the output circuitry 150 stores the result directly to the edge storage 160.

The data host 120 includes external data 170. In some examples, the external data 170 includes data from big data sources and may be retrieved by the data host 120 when the data retriever circuitry 130 retrieved the data from the data host 120 via the network 125. In some examples, the data host 120 includes the storage 180, which houses data that can be retrieved/accessed by the data retriever circuitry 130, via the network 125 and/or directly.

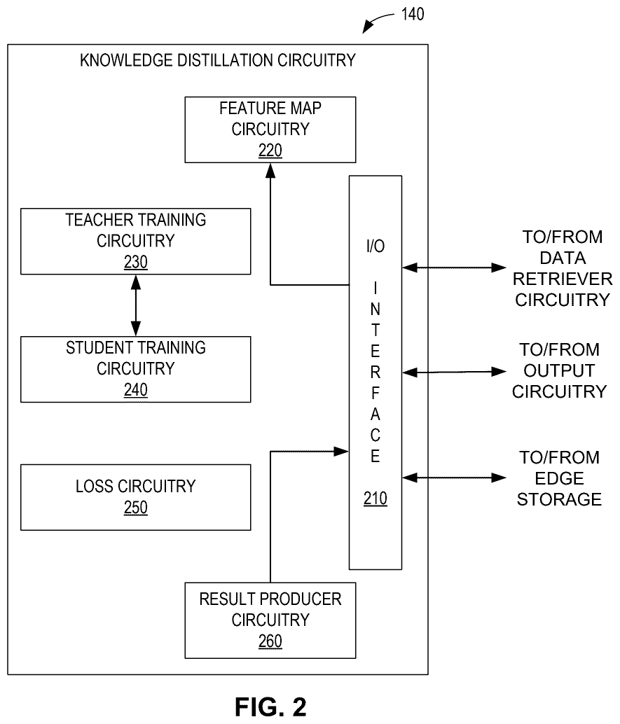

FIG. 2 is a block diagram of example knowledge distillation circuitry 140 to train the teacher network 410 and the student network 420. The knowledge distillation circuitry 140 of FIG. 2 may be instantiated (e.g., creating an instance of, bring into being for any length of time, materialize, implement, etc.) by processor circuitry such as a central processing unit executing instructions. Additionally or alternatively, the knowledge distillation circuitry 140 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The knowledge distillation circuitry 140 includes feature map circuitry 220, teacher training circuitry 230, student training circuitry 240, loss circuitry 250, and result producer circuitry 260.

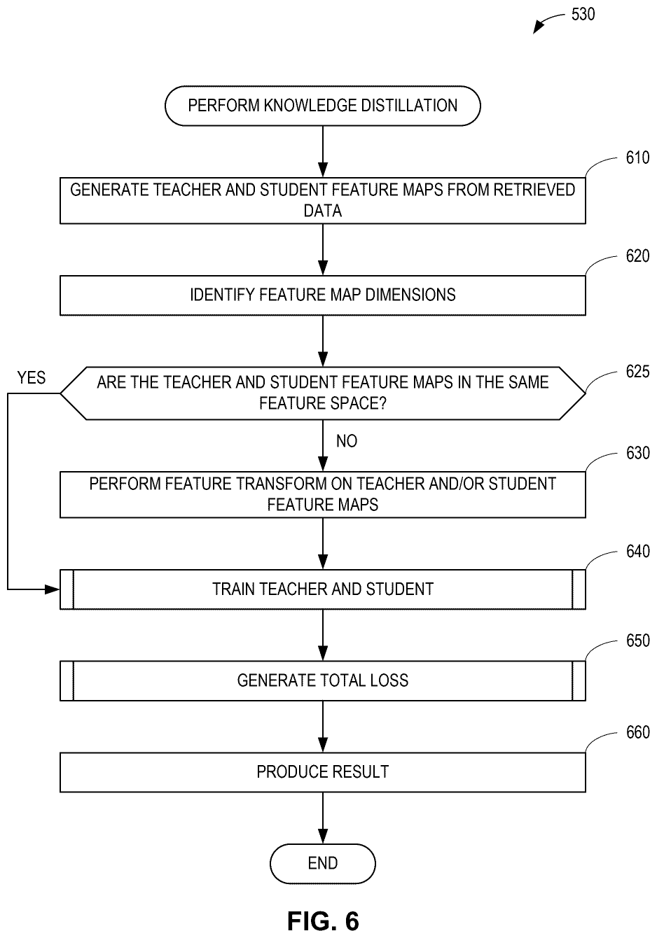

The feature map circuitry 220 generates teacher and student feature maps (e.g., a teacher feature map 440 and a student feature map 450) from the data retrieved by the data retriever circuitry 130 based upon the teacher network 410 and the student network 420 respectively. In some examples, the feature maps 440, 450 are generated based on a query received by the data retriever circuitry 130. In some examples, the feature map circuitry 220 communicates with the data retriever circuitry 130, the output circuitry 150, and/or the edge storage 160 via an I/O interface 210. In some examples, the feature map circuitry 220 is instantiated by processor circuitry executing feature map instructions and/or configured to perform operations such as those represented by the flowchart of FIG. 6.

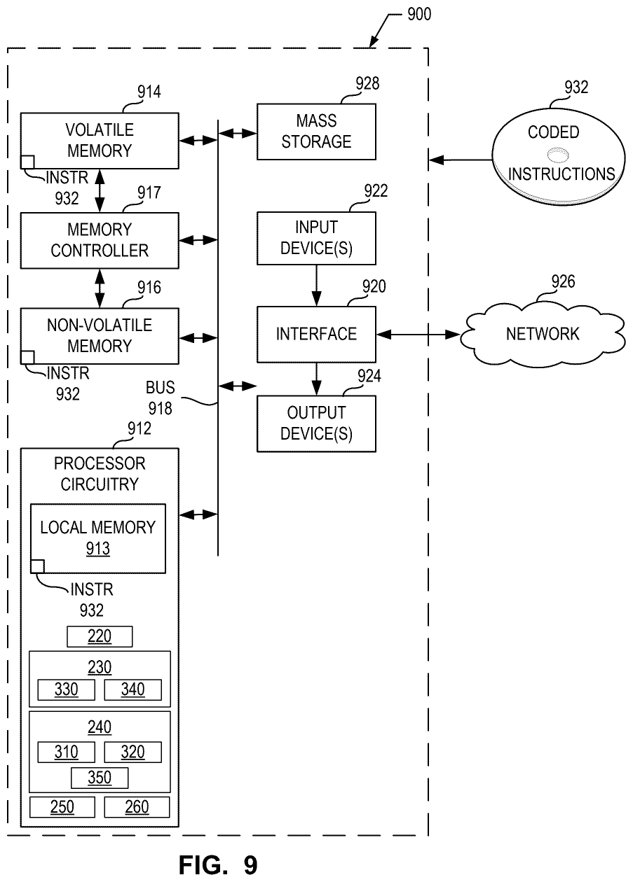

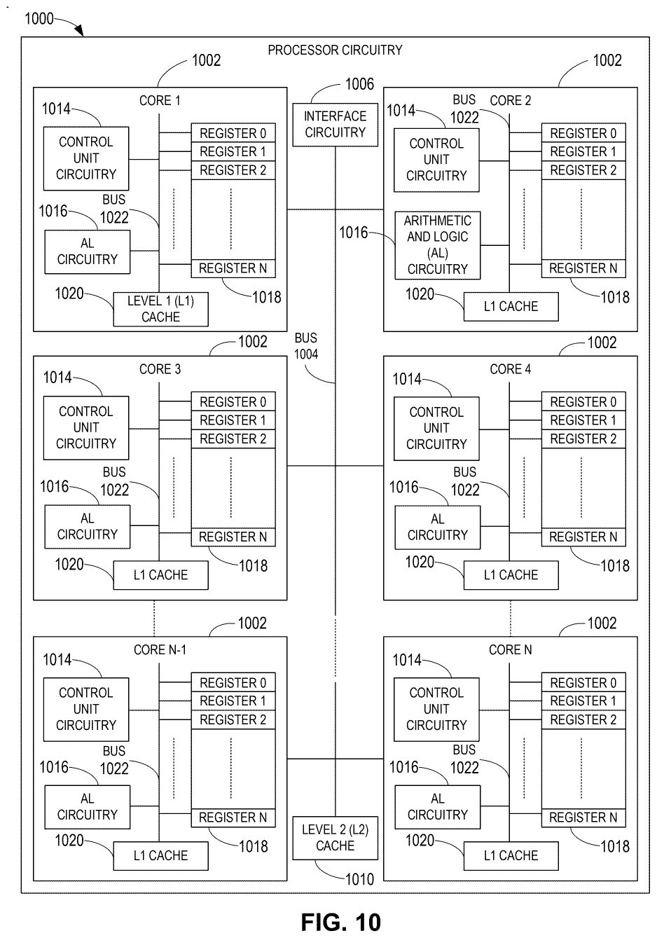

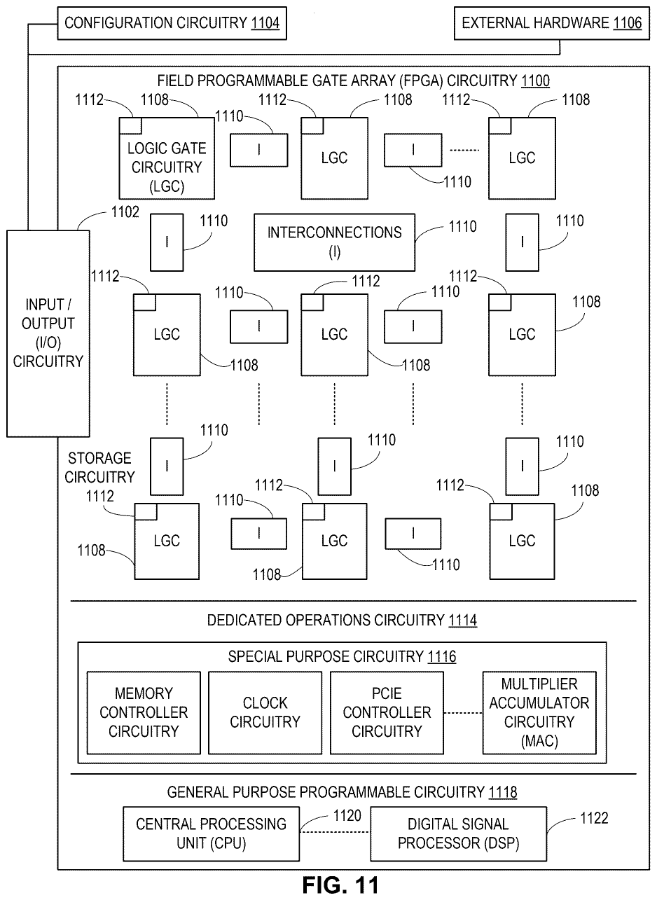

In some examples, the knowledge distillation circuitry 140 includes means for generating teacher and student feature maps 440, 450. For example, the means for generating may be implemented by feature map circuitry 220. In some examples, the feature map circuitry 220 may be instantiated by processor circuitry such as the example processor circuitry 912 of FIG. 9. For instance, the feature map circuitry 220 may be instantiated by the example microprocessor 1000 of FIG. 10 executing machine executable instructions such as those implemented by at least blocks 610, 620, and 630 of FIG. 6. In some examples, the feature map circuitry 220 may be instantiated by hardware logic circuitry, which may be implemented by an ASIC, XPU, or the FPGA circuitry 1100 of FIG. 11 structured to perform operations corresponding to the machine readable instructions. Additionally or alternatively, the feature map circuitry 220 may be instantiated by any other combination of hardware, software, and/or firmware. For example, the feature map circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The teacher training circuitry 230 trains the teacher network 410. In some examples, the teacher training circuitry 230 communicates with the student training circuitry 240 while training the teacher network 410. In some examples, the teacher training circuitry 230 is instantiated by processor circuitry executing teacher training instructions and/or configured to perform operations such as those represented by the flowcharts of FIGS. 6 and/or 7.

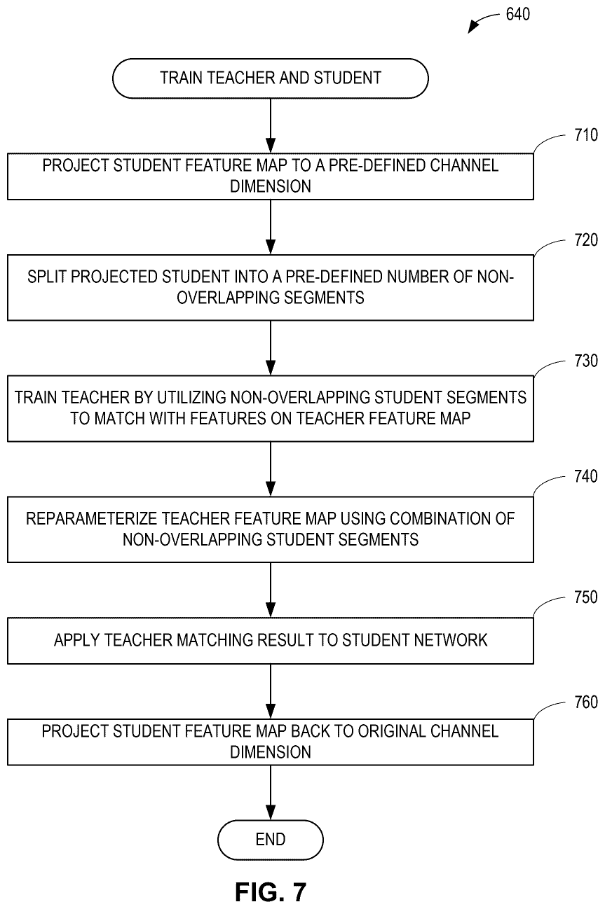

In some examples, the knowledge distillation circuitry 140 includes means for training the teacher network 410. For example, the means for training the teacher network 410 may be implemented by teacher training circuitry 230. In some examples, the teacher training circuitry 230 may be instantiated by processor circuitry such as the example processor circuitry 912 of FIG. 9. For instance, the teacher training circuitry 230 may be instantiated by the example microprocessor 1000 of FIG. 10 executing machine executable instructions such as those implemented by at least blocks 640 of FIGS. 6 and/or 730 and/or 740 of FIG. 7. In some examples, the teacher training circuitry 230 may be instantiated by hardware logic circuitry, which may be implemented by an ASIC, XPU, or the FPGA circuitry 1100 of FIG. 11 structured to perform operations corresponding to the machine readable instructions. Additionally or alternatively, the teacher training circuitry 230 may be instantiated by any other combination of hardware, software, and/or firmware. For example, the teacher training circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The student training circuitry 240 trains the student network 420. In some examples, the student training circuitry 240 communicates with the teacher training circuitry 230 while training the student network 420. In some examples, the student training circuitry 240 is instantiated by processor circuitry executing student training instructions and/or configured to perform operations such as those represented by the flowcharts of FIGS. 6 and/or 7.

In some examples, the knowledge distillation circuitry 140 includes means for training the student network 420. For example, the means for training the student network 420 may be implemented by student training circuitry 240. In some examples, the student training circuitry 240 may be instantiated by processor circuitry such as the example processor circuitry 912 of FIG. 9. For instance, the student training circuitry 240 may be instantiated by the example microprocessor 1000 of FIG. 10 executing machine executable instructions such as those implemented by at least blocks 640 of FIGS. 6 and/or 710, 720, 750, and/or 760 of FIG. 7. In some examples, the student training circuitry 240 may be instantiated by hardware logic circuitry, which may be implemented by an ASIC, XPU, or the FPGA circuitry 1100 of FIG. 11 structured to perform operations corresponding to the machine readable instructions. Additionally or alternatively, the student training circuitry 240 may be instantiated by any other combination of hardware, software, and/or firmware. For example, the student training circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The loss circuitry 250 calculates a total loss value of the teacher and student networks 410, 420. In some examples, the loss circuitry 250 is instantiated by processor circuitry executing loss instructions and/or configured to perform operations such as those represented by the flowcharts of FIGS. 6 and/or 8.

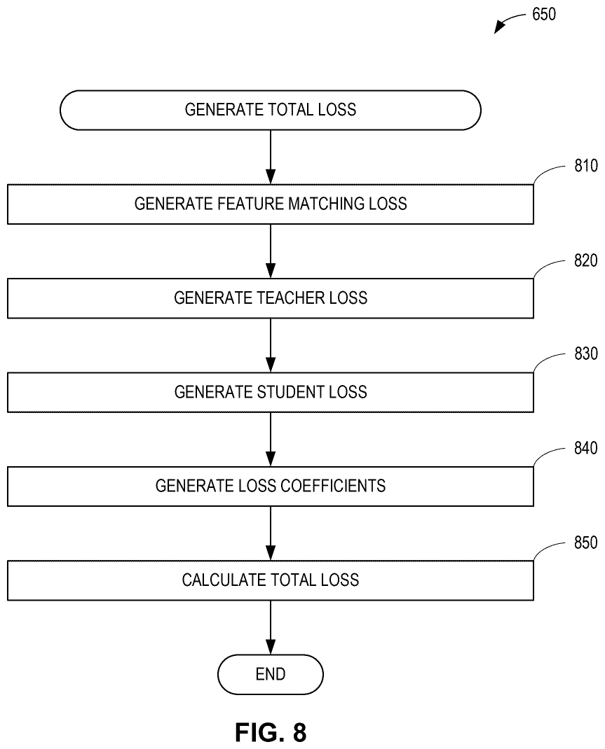

In some examples, the knowledge distillation circuitry 140 includes means for calculating a total loss value. For example, the means for calculating may be implemented by loss circuitry 250. In some examples, the loss circuitry 250 may be instantiated by processor circuitry such as the example processor circuitry 912 of FIG. 9. For instance, the loss circuitry 250 may be instantiated by the example microprocessor 1000 of FIG. 10 executing machine executable instructions such as those implemented by at least blocks 650 of FIGS. 6 and/or 810, 820, 830, 840, and/or 850 of FIG. 8. In some examples, the loss circuitry 250 may be instantiated by hardware logic circuitry, which may be implemented by an ASIC, XPU, or the FPGA circuitry 1100 of FIG. 11 structured to perform operations corresponding to the machine readable instructions. Additionally or alternatively, the loss circuitry 250 may be instantiated by any other combination of hardware, software, and/or firmware. For example, the loss circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The result producer circuitry 260 produces a result based on the training of the teacher and student networks 410, 420. In some examples, the result producer circuitry 260 communicates with the data retriever circuitry 130, the output circuitry 150, and/or the edge storage 160 via the I/O interface 210. In some examples, the result producer circuitry 260 is instantiated by processor circuitry executing result instructions and/or configured to perform operations such as those represented by the flowchart of FIG. 6.

In some examples, the knowledge distillation circuitry 140 includes means for producing a result. For example, the means for producing may be implemented by result producer circuitry 260. In some examples, the result producer circuitry 260 may be instantiated by processor circuitry such as the example processor circuitry 912 of FIG. 9. For instance, the result producer circuitry 260 may be instantiated by the example microprocessor 1000 of FIG. 10 executing machine executable instructions such as those implemented by at least block 660 of FIG. 6. In some examples, the result producer circuitry 260 may be instantiated by hardware logic circuitry, which may be implemented by an ASIC, XPU, or the FPGA circuitry 1100 of FIG. 11 structured to perform operations corresponding to the machine readable instructions. Additionally or alternatively, the result producer circuitry 260 may be instantiated by any other combination of hardware, software, and/or firmware. For example, the result producer circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

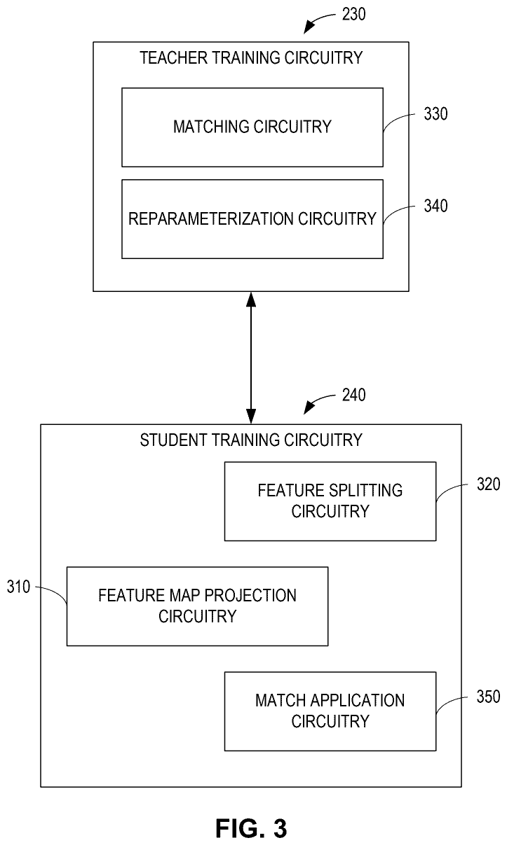

FIG. 3 is a block diagram of the example teacher training circuitry 230 and the example student training circuitry 240 to train the teacher network 410 and the student network 420, respectively. The teacher training circuitry 230 and the student training circuitry 240 of FIG. 3 may be instantiated (e.g., creating an instance of, bring into being for any length of time, materialize, implement, etc.) by processor circuitry such as a central processing unit executing instructions. Additionally or alternatively, the teacher training circuitry 230 and the student training circuitry 240 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

The teacher training circuitry 230 and the student training circuitry 240 include feature map projection circuitry 310, feature splitting circuitry 320, matching circuitry 330, reparameterization circuitry 340, and match application circuitry 350. In some examples, the student training circuitry 240 includes the feature map projection circuitry 310, the feature splitting circuitry 320, and the match application circuitry 350. In some examples, the teacher training circuitry 230 includes the matching circuitry 330 and the reparameterization circuitry 340.

The feature map projection circuitry 310 projects the student feature map 450 to a desired channel dimension. In some examples, the feature map projection circuitry 310 projects the student feature map 450 into a pre-defined channel dimension prior to training the student network 420, where the pre-defined channel dimension is used for a many-to-one representation of the teacher network 410. In some examples, the feature map projection circuitry 310 projects the student feature map 450 back to its original channel dimension after the student network 420 has been trained. In some examples, the feature map projection circuitry 310 is instantiated by processor circuitry executing feature map projection instructions and/or configured to perform operations such as those represented by the flowchart of FIG. 7.

In some examples, the student training circuitry 240 includes means for projecting the student feature map 450 to a desired channel dimension. For example, the means for projecting may be implemented by feature map projection circuitry 310. In some examples, the feature map projection circuitry 310 may be instantiated by processor circuitry such as the example processor circuitry 912 of FIG. 9. For instance, the feature map projection circuitry 310 may be instantiated by the example microprocessor 1000 of FIG. 10 executing machine executable instructions such as those implemented by at least blocks 710 and 760 of FIG. 7. In some examples, the feature map projection circuitry 310 may be instantiated by hardware logic circuitry, which may be implemented by an ASIC, XPU, or the FPGA circuitry 1100 of FIG. 11 structured to perform operations corresponding to the machine readable instructions. Additionally or alternatively, the feature map projection circuitry 310 may be instantiated by any other combination of hardware, software, and/or firmware. For example, the feature map projection circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The feature splitting circuitry 320 splits the student feature map 450 into segments that are the same channel dimension as the teacher feature map 440. In some examples, the feature splitting circuitry 320 is instantiated by processor circuitry executing feature splitting instructions and/or configured to perform operations such as those represented by the flowchart of FIG. 7.

In some examples, the student training circuitry 240 includes means for splitting the student feature map 450 into segments that are the same channel dimension as the teacher feature map 440. For example, the means for splitting may be implemented by feature splitting circuitry 320. In some examples, the feature splitting circuitry 320 may be instantiated by processor circuitry such as the example processor circuitry 912 of FIG. 9. For instance, the feature splitting circuitry 320 may be instantiated by the example microprocessor 1000 of FIG. 10 executing machine executable instructions such as those implemented by at least block 720 of FIG. 7. In some examples, the feature splitting circuitry 320 may be instantiated by hardware logic circuitry, which may be implemented by an ASIC, XPU, or the FPGA circuitry 1100 of FIG. 11 structured to perform operations corresponding to the machine readable instructions. Additionally or alternatively, the feature splitting circuitry 320 may be instantiated by any other combination of hardware, software, and/or firmware. For example, the feature splitting circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The matching circuitry 330 matches the segments of the student feature map 450 created by the feature splitting circuitry 320 to the teacher feature map 440. In some examples, the matching circuitry 330 is instantiated by processor circuitry executing matching instructions and/or configured to perform operations such as those represented by the flowchart of FIG. 7.

In some examples, the teacher training circuitry 230 includes means for matching the segments of the student feature map 450 to the teacher feature map 440. For example, the means for matching may be implemented by matching circuitry 330. In some examples, the matching circuitry 330 may be instantiated by processor circuitry such as the example processor circuitry 912 of FIG. 9. For instance, the matching circuitry 330 may be instantiated by the example microprocessor 1000 of FIG. 10 executing machine executable instructions such as those implemented by at least block 730 of FIG. 7. In some examples, the matching circuitry 330 may be instantiated by hardware logic circuitry, which may be implemented by an ASIC, XPU, or the FPGA circuitry 1100 of FIG. 11 structured to perform operations corresponding to the machine readable instructions. Additionally or alternatively, the matching circuitry 330 may be instantiated by any other combination of hardware, software, and/or firmware. For example, the matching circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The reparameterization circuitry 340 reparametrizes the teacher network 410 based on a combination (e.g., a summation) of the segments of the student feature map 450. In some examples, the reparameterization circuitry 340 is instantiated by processor circuitry executing reparameterization instructions and/or configured to perform operations such as those represented by the flowchart of FIG. 7.

In some examples, the teacher training circuitry 230 includes means for reparametrizes the teacher network 410 based on a combination of the segments of the student feature map 450. For example, the means for reparametrizing may be implemented by reparameterization circuitry 340. In some examples, the reparameterization circuitry 340 may be instantiated by processor circuitry such as the example processor circuitry 912 of FIG. 9. For instance, the reparameterization circuitry 340 may be instantiated by the example microprocessor 1000 of FIG. 10 executing machine executable instructions such as those implemented by at least block 740 of FIG. 7. In some examples, the reparameterization circuitry 340 may be instantiated by hardware logic circuitry, which may be implemented by an ASIC, XPU, or the FPGA circuitry 1100 of FIG. 11 structured to perform operations corresponding to the machine readable instructions. Additionally or alternatively, the reparameterization circuitry 340 may be instantiated by any other combination of hardware, software, and/or firmware. For example, the reparameterization circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The match application circuitry 350 applies a result of the matching of the segments of the student feature map 450 to the teacher network 410 to the student network 420. In some examples, the match application circuitry 350 is instantiated by processor circuitry executing match application instructions and/or configured to perform operations such as those represented by the flowchart of FIG. 7.

In some examples, the student training circuitry 240 includes means for applying a result of the matching of the segments of the student feature map 450 to the teacher network 410 to the student network 420. For example, the means for applying may be implemented by match application circuitry 350. In some examples, the match application circuitry 350 may be instantiated by processor circuitry such as the example processor circuitry 912 of FIG. 9. For instance, the match application circuitry 350 may be instantiated by the example microprocessor 1000 of FIG. 10 executing machine executable instructions such as those implemented by at least block 750 of FIG. 7. In some examples, the match application circuitry 350 may be instantiated by hardware logic circuitry, which may be implemented by an ASIC, XPU, or the FPGA circuitry 1100 of FIG. 11 structured to perform operations corresponding to the machine readable instructions. Additionally or alternatively, the match application circuitry 350 may be instantiated by any other combination of hardware, software, and/or firmware. For example, the match application circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the reparameterization circuitry 240 and the match application circuitry 250 execute in parallel to train the teacher network 410 and the student network 420 simultaneously. In other examples, the reparameterization circuitry 240 and the match application circuitry 250 execute in series. The order in which the reparameterization circuitry 240 and the match application circuitry 250 execute is interchangeable and/or modifiable. In other words, the order of execution of either of the reparameterization circuitry 240 and the match application circuitry 250 is not limited to the specific examples described herein.

While an example manner of implementing the knowledge distillation circuitry 140 of FIG. 1 is illustrated in FIGS. 2 and/or 3, one or more of the elements, processes, and/or devices illustrated in FIGS. 2 and/or 3 may be combined, divided, re-arranged, omitted, eliminated, and/or implemented in any other way. Further, the example feature map circuitry 220, example teacher training circuitry 230, example student training circuitry 240, example loss circuitry 250, example result producer circuitry 260, example feature map projection circuitry 310, example feature splitting circuitry 320, example matching circuitry 330, example reparameterization circuitry 340, example match application circuitry 350 and/or, more generally, the example knowledge distillation circuitry 140 of FIG. 1, may be implemented by hardware alone or by hardware in combination with software and/or firmware. Thus, for example, any of the example feature map circuitry 220, example teacher training circuitry 230, example student training circuitry 240, example loss circuitry 250, example result producer circuitry 260, example feature map projection circuitry 310, example feature splitting circuitry 320, example matching circuitry 330, example reparameterization circuitry 340, example match application circuitry 350, and/or, more generally, the example knowledge distillation circuitry 140, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPL D(s)) such as Field Programmable Gate Arrays (FPGAs). Further still, the example knowledge distillation circuitry 140 of FIG. 1 may include one or more elements, processes, and/or devices in addition to, or instead of, those illustrated in FIGS. 2 and/or 3, and/or may include more than one of any or all of the illustrated elements, processes and devices.

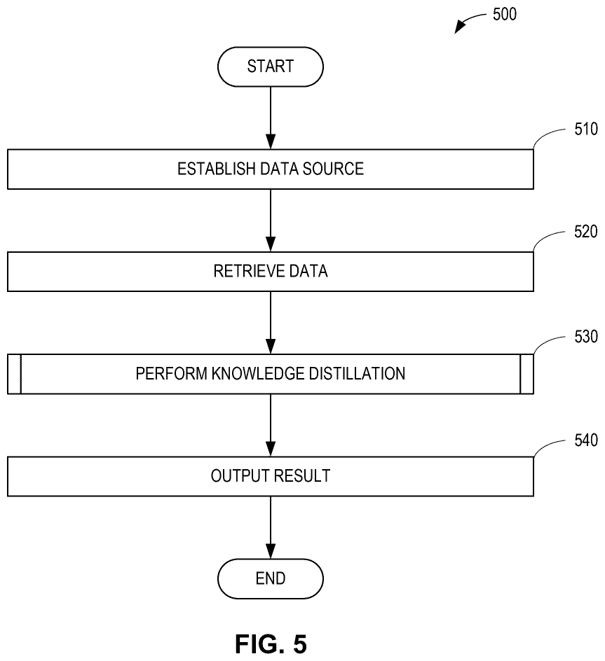

Flowcharts representative of example machine readable instructions, which may be executed to configure processor circuitry to implement the knowledge distillation circuitry 140 of FIG. 2, is shown in FIGS. 5, 6, 7, and/or 8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5, 6, 7, and/or 8, many other methods of implementing the example knowledge distillation circuitry 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5, 6, 7, and/or 8 may be implemented using executable instructions (e.g., computer and/or machine readable instructions) stored on one or more non-transitory computer and/or machine readable media such as optical storage devices, magnetic storage devices, an H DID, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

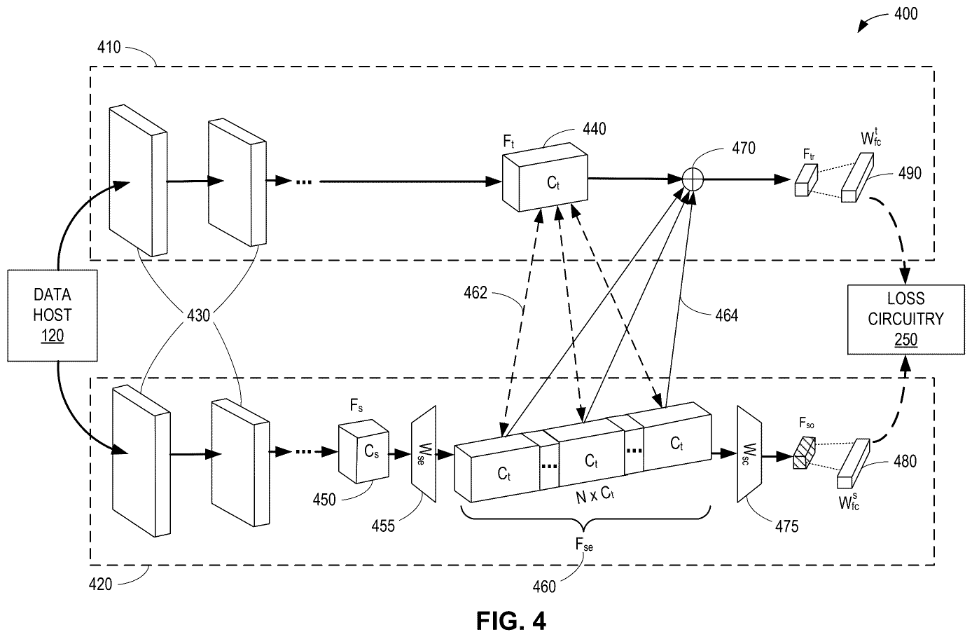

FIG. 4 is an operational representation of the knowledge distillation architecture 100 of FIG. 1. The example illustrated operation 400 includes the data host 120, the loss circuitry 250, the teacher network 410, the student network 420, and a plurality of convolutional layers 430. The teacher network 410 includes the teacher feature map 440. The student network 420 includes the student feature map 450. The illustrated operation 400 can be inserted at any convolutional layer of the plurality of convolutional layers 430. Depending on the neural network, the illustrated operation 400 of FIG. 4 may be inserted at more than one convolutional layer.

The teacher feature map 440 (also represented as Fₜ) includes a teacher channel dimension Cₜ. The student feature map 450 (also represented as Fₛ) includes a student channel dimension Cₛ. In the examples described herein, the teacher channel dimension Cₜ is different than the student channel dimension Cₛ. Therefore, the student feature map 450 should be projected to a channel dimension equivalent to the teacher channel dimension Cₜ.

The student network 420 is used by a student channel dimension expander 455 (also referred to as Wₛₑ) to project the student feature map 450 into a channel dimension that is the same as the teacher channel dimension Cₜ. The student network 420 then splits the projected student feature map into an expanded student feature map 460 (also referred to as Fₛₑ) with N non-overlapping segments. Therefore, the expanded student feature map 460 is represented as N×Cₜ, since each non-overlapping segment N is the same channel dimension as the teacher feature map 440.

The teacher network 410 is used to perform a many-to-one feature representation using the N non-overlapping segments of the expanded student feature map 460 by matching features on the expanded student feature map 460 to features on the teacher feature map 440.

The teacher network 410 is used by a reparametrizer 470 to reparametrize the teacher feature map 440, where the reparametrizer 470 uses a combination of the N non-overlapping segments of the expanded student feature map 460. In some examples, the combination may be a summation of the N non-overlapping segments. In other examples, the combination may be a difference, a multiplication, a division, etc.

The student network 420 is used to apply a result of the matching of the N non-overlapping segments to the expanded student feature map 460. As disclosed above, the reparameterization of the teacher feature map 440 using the reparametrizer 470 and the applying of the result from the matching of the N non-overlapping segments may be performed in parallel.

The student network 420 is used by the student channel dimension contractor 475 (also referred to as W_{sc}) to create an output student feature map. Such creation of the output student feature may be accomplished by projection of the expanded student feature map 560 back to its original channel dimension Cₛ. The output student feature map, also referred to as Fₛₒ, is then weighted to represent a fully connected student network layer 480 (e.g., the convolutional layer has been fully learnt), also referred as

$${W}_{f c}^{s} .$$

Likewise, the teacher network 410 is used to weigh the reparametrized teacher feature map, also referred to as Fₜᵣ, to represent a fully connected teacher network layer 490 (e.g., the convolutional layer has been fully learnt), also referred to as

$${W}_{f c}^{t} .$$

The fully connected student layer 480 and the fully connected teacher layer 490 are passed to the loss circuitry 250 to calculate a total loss value. The calculation of the total loss value is further described in reference to the flow chart of FIG. 8 below.

FIG. 5 is a flowchart representative of example machine readable instructions and/or example operations that may be executed and/or instantiated by processor circuitry to implement the knowledge distillation architecture 100 of FIG. 1. The knowledge distillation process 500 of FIG. 5 begin at block 510, where the data retriever circuitry 130 establishes a data source for the data to be retrieved. In some examples, as described above, the data may be housed in external data 170 (e.g., online sources, big data sources, etc.) that can be accessed over the network 125 or housed in the storage 180 that can be accessed directly by the data retriever circuitry 170. In such an example, the data retriever circuitry 130 can establish the source of the data, whether it be from the external data 170 or the storage 180.

The knowledge distillation process 500 then proceeds where the data retriever circuitry 130 retrieves the data from the data source established. (Block 520). In some examples, the data may be stored on internal storage buffers within the edge device 110. In other examples, the data may be temporarily stored in the edge storage 160. In yet other examples, the data may not be stored and may be passed directly to the knowledge distillation circuitry 140, where the data is then deleted once the knowledge distillation process 500 completes.

Next, the knowledge distillation circuitry 140 performs the knowledge distillation on the data retrieved by the data retriever circuitry 130. (Block 530). In some examples, the knowledge distillation circuitry 140 accesses data from the data retriever circuitry 130. In other examples, the knowledge distillation circuitry 140 accesses data stored on the edge storage 160.

Once the knowledge distillation circuitry 140 performs the knowledge distillation on the retrieved data, the output circuitry 150 outputs a result of the knowledge distillation. (Block 540). In some examples, the result is passed to the data host 120 via the network 125 to output the result to a graphical user interface (GUI) for an operator to view the result. In other examples, the result is stored to the edge storage 160 and/or the storage 180 on the data host 120.

FIG. 6 is a flowchart representative of example machine readable instructions and/or example operations that may be executed and/or instantiated by processor circuitry to perform the knowledge distillation on the data retrieved by the data retriever circuitry 130. Performing the knowledge distillation of FIG. 6 begin at block 610, where the feature map circuitry 220 generates the teacher feature map 440 and the student feature map 450.

Once the teacher feature map 440 and the student feature map 450 are generated, the feature map circuitry 220 identifies the channel dimensions for the teacher feature map 440 and the student feature map 450. (Block 620). In the examples described herein and as stated above, the teacher feature map 440 has a different channel dimension than the student feature map 450. In some examples the channel dimension includes a channel height, width, and number, representative of a three-dimensional feature map. In other examples, the feature maps 440, 450 may have additional dimensions or less dimensions.

The feature map circuitry 220 then determines whether the teacher feature map 440 and the student feature map 450 are in the same feature space. (Block 625). In some examples, the teacher feature map 440 is in a different feature space (e.g., the dimensions in which the features of the teacher feature map are stored) than the feature space of the student feature map 450. In such an example, once the feature map circuitry 220 identifies the feature map 440, 450 channel dimensions, the feature map circuitry 220 should transform the feature maps 440, 450 into the same feature space.

When the feature map circuitry 220 determined that the teacher and student maps 440, 450 are not in the same feature space (e.g., block 625 returns a result of NO), the feature map circuitry 220 can then perform a feature transform on the teacher feature map 440 and/or the student feature map 450 to project the feature maps 440, 450 into the same feature space. (Block 630). In some examples, both feature maps 440, 450 can be transformed into the same feature space. Such an example may be desired to reduce computational complications by reducing channel dimensions, modifying channel dimensions, etc. In other examples, only one of the feature maps 440, 450 may be transformed.

Once the feature maps 440, 450 are transformed by the feature map circuitry 220 or when the feature map circuitry 220 determined that the feature maps 440, 450 are in the same feature space (e.g., block 625 returns a result of YES), then the teacher training circuitry 230 and the student training circuitry 240 train the teacher network 410 and the student network 420 respectively. (Block 640). In the examples described herein, the teacher network 410 and the student network 420 are trained simultaneously (e.g., in parallel). In other examples, however, the teacher network 410 and the student network 420 may be trained in series.

Once the teacher training circuitry 230 and the student training circuitry 240 train the teacher network 410 and the student network 420, the loss circuitry 250 generates a total loss value based on the trained teacher and student networks 410, 420. (Block 650). In some examples, the total loss value is a result of a teacher network loss and a student network loss. In other examples, the total loss value may include additional loss characteristics. Further information regarding generating the total loss value is disclosed with reference to FIG. 8

Once the total loss value is generated by the loss circuitry 250, the result producer circuitry 260 produces a result to be sent to the output circuitry 150. (Block 660). In some examples, the result is a report of the success, failure, efficiency, etc., of the knowledge distillation process performed. In some examples, the result is produced in a format for a user to visualize the result of the training of the teacher and student networks 410, 420. In other examples, the result may be stored to the edge storage 160 and/or the storage 180. Once the result is produced by the result producer circuitry 260, the example operations of the flowchart of FIG. 6 is complete.

FIG. 7 is a flowchart representative of example machine readable instructions and/or example operations that may be executed and/or instantiated by processor circuitry to train the teacher network 410 and the student network 420. Training the teacher network 410 and student network 420 of FIG. 7 begin at block 710, at which the feature map projection circuitry 310 projects the student feature map 450 to a pre-defined channel dimension. In some examples, the pre-defined channel dimension is equal to the channel dimension of the teacher feature map 440.

Once the student feature map 440 is projected to a pre-defined channel dimension by the feature map projection circuitry 310, the feature splitting circuitry 320 then splits the projected student feature map into a pre-defined number of non-overlapping segments (e.g., the expanded student feature map 460) with the same channel dimension as the teacher feature map 440. (Block 720). Any number of non-overlapping segments may be used to create the many-to-one feature representation as described above. In some examples, fewer (e.g., eight or less) non-overlapping segments may be desired to increase computational time. In other examples, more than eight non-overlapping segments may be desired to increase the accuracy of the learning process and decrease the total loss value.

Once the student feature map 450 has been split into a pre-defined number of non-overlapping segments, the matching circuitry 330 then begins training the teacher by matching the non-overlapping segments of the expanded student feature map 460 to features on the teacher feature map 440. (Block 730). In some examples, the matching circuitry 330 matches the non-overlapping segments to preserve information passed from the student network 420 to the teacher network 410 and then back to the student network 420. The matching of the non-overlapping segments allows for the teacher network 410 to learn from many features of the expanded student feature map 460, whereas traditional neural networks use a one-to-one feature representation which increases computational time to produce the same result as the many-to-one feature representation described herein.

Once the matching circuitry 330 matches the non-overlapping segments to the teacher feature map 440, the reparameterization circuitry 340 reparametrizes the teacher feature map 440 using a combination of the non-overlapping student segments. (Block 740). In some examples, the reparameterization circuitry 330 allows for backwards propagation through the teacher network 410 and the student network 420. The reparameterization circuitry 340 furthers the learning process for the teacher network 450.

Alternatively, or simultaneously, the match application circuitry 350 applies a result of the matching of the non-overlapping segments to the expanded student feature map 460. (Block 750). In some examples, the application of the result of the matching of the non-overlapping segments trains the student network based on the output of the matching circuitry 330. In the examples described herein, the reparameterization circuitry 340 and the match application circuitry 350 can be performed in parallel to train the teacher network 440 and the student network 450 simultaneously.

Once the teacher feature map 440 has been reparametrized and the matching of the non-overlapping segments has been applied to the expanded student feature map 460, then the feature map projection circuitry 310 projects the expanded student feature map 460 back to the original channel dimension (e.g., the channel dimension of the student feature map 450). (Block 760). In some examples, the projection back to the original channel dimension is to allow the loss calculation to be performed on the output student feature map, Fₛₒ. Once the expanded student feature map 460 has been projected back to its original channel dimension, then the training of the teacher and student networks 410, 420 is complete.

FIG. 8 is a flowchart representative of example machine readable instructions and/or example operations that may be executed and/or instantiated by processor circuitry to generate a total loss value. Generating the total loss value of FIG. 8 begin at block 810, at which the loss circuitry 250 generates a feature matching loss. In some examples, the feature matching loss is represented by Equation 1 below:

$${L}_{m o f d} = \frac{1}{N} {\sum }_{i = 1}^{N} d ( {F}_{se}^{i} , {F}_{t} ) \qquad Equation 1$$

As represented in Equation 1, N represents the number of non-overlapping segments (e.g., split from the student feature map 450), Fₛₑ represents the expanded student feature map 460, and Fₜ represents the teacher feature map 440.

The loss circuitry 250 generates a teacher network loss after the teacher has been reparametrized (e.g., corresponding to the instructions of block 740). (Block 820). Generating the teacher network loss is represented by Equation 2 below:

$${L}_{t} = CE ( Softmax ( {W}_{f c}^{t} * ( {F}_{t} + {\sum }_{i = 1}^{N} {F}_{s e}^{i} ) ) , GT ) \qquad Equation 2$$

As represented by Equation 2,

$${W}_{f c}^{t}$$

is the weight of the fully connected teacher network layer (e.g., fully learnt layer). CE is a cross entropy loss (e.g., also known as log loss) which measures a performance of a classification model whose output is a probability value between 0 and 1. Softmax is a normalized exponential function that converts a vector of real numbers into a probability distribution of possible outcomes. Lastly, GT is a ground truth (e.g., a target for training or validating the neural network with a labeled dataset).

The loss circuitry 250 generates a student network loss after the student has been projected back to its original channel dimension (e.g., corresponding to the instructions of block 760). (Block 830). Generating the student network loss if represented by Equation 3 below:

$${L}_{s} = C E ( {W}_{f c}^{s} * {F}_{s} , GT ) \qquad Equation 3$$

As represented by Equation 3,

$${W}_{f c}^{s}$$

is the weight of the fully connected student network layer (e.g., fully learnt layer).

Corresponding to each individual loss contribution (e.g., the feature matching loss L_{mofd}, the teacher network loss Lₜ, and the student network loss Lₛ), the loss circuitry 250 generates loss coefficients for each loss contribution. (Block 840). In some examples, the loss coefficients, represented as a student network loss coefficient α, a teacher network loss coefficient β, and a feature matching loss coefficient γ, are generated through experimental analysis (e.g., updating the loss coefficients based on the result of the previous loss calculation). In other examples, the loss coefficients are constant.

Once the loss coefficients are generated, the loss circuitry 250 calculates the total loss value. (Block 850). Calculating the total loss value is represented by Equation 4 below:

L=α·Lₛ+β·Lₜ+γ·L_{mofd} Equation 4

As represented by Equation 4 above, L represents the total loss value as a combination of the feature matching loss L_{mofd} with the feature matching loss coefficient γ, the teacher network loss Lₜ with the teacher network loss coefficient β, and the student network loss Lₛ with the student network loss coefficient α. The total loss value is used in the output of the result of the learning process for the teacher network 410 and the student network 420. During every learn cycle (e.g., the instructions of FIG. 5), the total loss value is re-calculated, and the result is therefore different, where the neural network learns from the result to output a better (e.g., more accurate with less data) result on subsequent learn cycles.

FIG. 9 is a block diagram of an example processor platform 900 structured to execute and/or instantiate the machine readable instructions and/or the operations of FIGS. 5, 6, 7, and/or 8 to implement the knowledge distillation circuitry 140 of FIG. 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a headset (e.g., an augmented reality (AR) headset, a virtual reality (V R) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the feature map circuitry 220, the teacher training circuitry 230, the student training circuitry 240, the loss circuitry 250, the result producer circuitry 260, the feature map projection circuitry 310, the feature splitting circuitry 320, the matching circuitry 330, the reparameterization circuitry 340, and the match application circuitry 350.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAM BUS® Dynamic Random Access Memory (RDRAM), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 5, 6, 7, and/or 8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 5, 6, 7, and/or 8 to effectively instantiate the knowledge distillation circuitry 140 of FIG. 2 as logic circuits to perform the operations corresponding to those machine readable instructions. In some such examples, the knowledge distillation circuitry 140 of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 5, 6, 7, and/or 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 5, 6, 7, and/or 8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 5, 6, 7, and/or 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 5, 6, 7, and/or 8. As such, the FPGA circuitry 1100 may be structured to effectively instantiate some or all of the machine readable instructions of the flowcharts of FIGS. 5, 6, 7, and/or 8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 5, 6, 7, and/or 8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 5, 6, 7, and/or 8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, N or gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 5, 6, 7, and/or 8 may be executed by one or more of the cores 1002 of FIG. 10, a second portion of the machine readable instructions represented by the flowcharts of FIGS. 5, 6, 7, and/or 8 may be executed by the FPGA circuitry 1100 of FIG. 11, and/or a third portion of the machine readable instructions represented by the flowcharts of FIGS. 5, 6, 7, and/or 8 may be executed by an ASIC. It should be understood that some or all of the knowledge distillation circuitry 140 of FIG. 2 may, thus, be instantiated at the same or different times. Some or all of the circuitry may be instantiated, for example, in one or more threads executing concurrently and/or in series. Moreover, in some examples, some or all of the knowledge distillation circuitry 140 of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

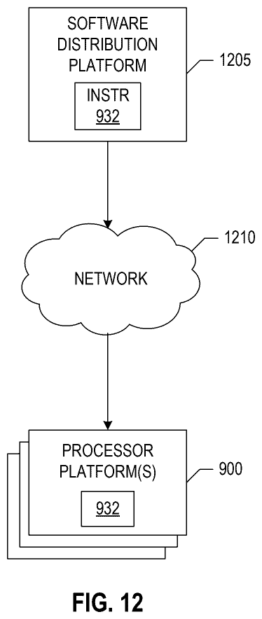

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 5, 6, 7, and/or 8, as described above. The one or more servers of the example software distribution platform 1205 are in communication with an example network 1210, which may correspond to any one or more of the Internet and/or any of the example networks 926 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 5, 6, 7, and/or 8, may be downloaded to the example processor platform 900, which is to execute the machine readable instructions 932 to implement the knowledge distillation circuitry 140. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that train a teacher network and a student network simultaneously without a pre-trained teacher model. Disclosed systems, methods, apparatus, and articles of manufacture improve the efficiency of using a computing device by using an online data source to train the teacher network and the student network simultaneously using a many-to-one feature representation approach. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to train a teacher network and a student network simultaneously without a pre-trained teacher model are disclosed herein. Further examples and combinations thereof include the following:

Example 1 includes an apparatus comprising at least one memory, machine readable instructions, and processor circuitry to at least one of instantiate or execute the machine readable instructions to generate a first feature map for a teacher network based a query, the first feature map having a first channel dimension, generate a second feature map for a student network based on the query, the second feature map having a second channel dimension, the second channel dimension different than the first channel dimension, split the second feature map into segments having the first channel dimension, train the teacher network using the segments of the second feature map, and train the student network by applying a total loss value to the student network, the total loss value based on a loss function, wherein the teacher network and the student network are trained on an edge device.

Example 2 includes the apparatus of example 1, wherein the processor circuitry is further to match the segments of the second feature map to the first feature map to train the teacher network.

Example 3 includes the apparatus of example 1, wherein the processor circuitry is further to reparametrize the teacher network based on the combination of the segments of the second feature map.

Example 4 includes the apparatus of example 1, wherein the processor circuitry is further to retrieve data from a data source, the data containing information related to the query.

Example 5 includes the apparatus of example 4, wherein the processor circuitry is further to establish the data source prior to retrieving the data.

Example 6 includes the apparatus of any of examples 1-5, wherein the processor circuitry is further to project the second feature map to a pre-defined channel dimension before performing the split, the pre-defined channel dimension different than the second channel dimension.

Example 7 includes the apparatus of example 6, wherein the processor circuitry is further to project the second feature map back to the second channel dimension after training the teacher network.

Example 8 includes the apparatus of example 1, wherein the segments of the second feature map are non-overlapping segments.

Example 9 includes the apparatus of example 1, wherein the processor circuitry is further to generate the total loss value.

Example 10 includes the apparatus of example 9, wherein the total loss value includes a combination of a matching loss corresponding to a matching of the segments of the second feature map to the first feature map, a teacher network loss, and a student network loss.

Example 11 includes the apparatus of example 1, wherein the processor circuitry is further to produce a result corresponding to the training of the teacher network and the student network.

Example 12 includes the apparatus of example 1, wherein the training of the teacher network and the student network are performed simultaneously.

Example 13 includes an apparatus for performing feature distillation in neural networks comprising means for generating a first feature map for a teacher network, the first feature map having a first channel dimension, and a second feature map for a student network, the second feature map having a second channel dimension different than the first channel dimension, means for splitting the second feature map into segments having the first channel dimension, first means for training the teacher network using the segments of the second feature map, and second means for training the student network using an output of a loss function, wherein the first and second means for training are implemented on an edge device.

Example 14 includes the apparatus of example 13, wherein the first means for training the teacher network further includes means for matching the segments of the second feature map to the first feature map.

Example 15 includes the apparatus of example 14, wherein the second means for training the student network further includes means for applying a result of the matching means to the student network.

Example 16 includes the apparatus of example 13, wherein the first means for training the teacher network further includes means for reparametrizing the teacher network based on the combination of the segments of the second feature map.

Example 17 includes the apparatus of example 13, wherein the second means for training the student network further includes means for projecting the second feature map to a pre-defined channel dimension before splitting the second feature map, the pre-defined channel dimension different than the second channel dimension.

Example 18 includes the apparatus of example 17, wherein the projecting means is a first means for projecting and the second means for training the student network further includes a second means for projecting the second feature map back to the second channel dimension after training the teacher network.

Example 19 includes the apparatus of example 13, further including means for calculating a total loss value, the total loss value corresponding to the output of the loss function.

Example 20 includes the apparatus of example 13, further including means for producing a result of the first and second training means.

Example 21 includes a non-transitory machine readable storage medium comprising instructions that, when executed, cause processor circuitry to at least generate a first feature map for a teacher network based on a query, the first feature map having a first channel dimension, generate a second feature map for a student network based on the query, the second feature map having a second channel dimension different than the first channel dimension, split the second feature map into segments having the first channel dimension, train the teacher network using the segments of the second feature map, and train the student network by applying a total loss value to the student network, the total loss value based on a loss function, wherein the teacher network and the student network are trained on an edge device.

Example 22 includes the non-transitory machine readable storage medium of example 21, wherein the instructions, when executed, further cause the processor circuitry to match the segments of the second feature map to the first feature map to train the teacher network.

Example 23 includes the non-transitory machine readable storage medium of example 21, wherein the instructions, when executed, further cause the processor circuitry to reparametrize the teacher network based on the combination of the segments of the second feature map.

Example 24 includes the non-transitory machine readable storage medium of example 21, wherein the instructions, when executed, further cause the processor circuitry to retrieve data from a data source, the data containing information related to the query.

Example 25 includes the non-transitory machine readable storage medium of example 24, wherein the instructions, when executed, further cause the processor circuitry to establish the data source prior to retrieving the data.

Example 26 includes the non-transitory machine readable storage medium of example 21, wherein the instructions, when executed, further cause the processor circuitry to project the second feature map to a pre-defined channel dimension before performing the split, the pre-defined channel dimension different than the second channel dimension.

Example 27 includes the non-transitory machine readable storage medium of any of examples 21-26, wherein the instructions, when executed, further cause the processor circuitry to project the second feature map back to the second channel dimension after training the teacher network.

Example 28 includes the non-transitory machine readable storage medium of example 21, wherein the instructions, when executed, further cause the processor circuitry to generate the total loss value using a combination of a matching loss corresponding to a matching of the segments of the second feature map to the first feature map, a teacher network loss, and a student network loss.

Example 29 includes the non-transitory machine readable storage medium of example 21, wherein the instructions, when executed, further cause the processor circuitry to produce a result corresponding to the training of the teacher network and the student network.

Example 30 includes a method for training a teacher network and a student network comprising generating a first feature map for a teacher network based on a query, the first feature map having a first channel dimension, generating a second feature map for a student network based on the query, the second feature map having a second channel dimension different than the first channel dimension, splitting the second feature map into segments having the first channel dimension, training the teacher network using the segments of the second feature map, and training the student network by applying a total loss value to the student network, wherein the training of the teacher network and the student network is performed on an edge device.

Example 31 includes the method of example 30, further including matching the segments of the second feature map to the first feature map to train the teacher network.

Example 32 includes the method of example 30, further including reparametrizing the teacher network based on the combination of the segments of the second feature map.

Example 33 includes the method of example 30, further including retrieving data from a data source, the data containing information related to the query.

Example 34 includes the method of example 33, further including establishing the data source prior to retrieving the data.

Example 35 includes the method of example 30, further including projecting the second feature map to a pre-defined channel dimension before performing the split, the pre-defined channel dimension different than the second channel dimension.

Example 36 includes the method of any of examples 30-35, further including projecting the second feature map back to the second channel dimension after training the teacher network.

Example 37 includes the method of example 30, further including generating the total loss value by employing a loss function.

Example 38 includes the method of example 30, wherein generating the total loss value further includes generating a matching loss corresponding to a matching of the segments of the second feature map to the first feature map, generating a teacher network loss, generating a student network loss, and calculating the total loss value by using a combination of the matching loss, the teacher network loss, and the student network loss.

Example 39 includes the method of example 30, further including producing a result corresponding to the training of the teacher network and the student network.

Example 40 includes the method of example 30, wherein the training of the teacher network and the student network are performed simultaneously.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to at least one of instantiate or execute the machine readable instructions to:
generate a first feature map for a teacher network based a query, the first feature map having a first channel dimension;
generate a second feature map for a student network based on the query, the second feature map having a second channel dimension, the second channel dimension different than the first channel dimension;
split the second feature map into segments having the first channel dimension;
train the teacher network using the segments of the second feature map; and
train the student network by applying a total loss value to the student network, the total loss value based on a loss function;
wherein the teacher network and the student network are trained on an edge device.

2. The apparatus of claim 1, wherein the processor circuitry is further to match the segments of the second feature map to the first feature map to train the teacher network.

3. The apparatus of claim 1, wherein the processor circuitry is further to reparametrize the teacher network based on the combination of the segments of the second feature map.

4. The apparatus of claim 1, wherein the processor circuitry is further to retrieve data from a data source, the data containing information related to the query.

5. The apparatus of claim 4, wherein the processor circuitry is further to establish the data source prior to retrieving the data.

6. The apparatus of claim 1, wherein the processor circuitry is further to project the second feature map to a pre-defined channel dimension before performing the split, the pre-defined channel dimension different than the second channel dimension.

7. The apparatus of claim 6, wherein the processor circuitry is further to project the second feature map back to the second channel dimension after training the teacher network.

8. The apparatus of claim 1, wherein the segments of the second feature map are non-overlapping segments.

9. The apparatus of claim 1, wherein the processor circuitry is further to generate the total loss value.

10. The apparatus of claim 9, wherein the total loss value includes a combination of a matching loss corresponding to a matching of the segments of the second feature map to the first feature map, a teacher network loss, and a student network loss.

11. The apparatus of claim 1, wherein the processor circuitry is further to produce a result corresponding to the training of the teacher network and the student network.

12. The apparatus of claim 1, wherein the training of the teacher network and the student network are performed simultaneously.

13. An apparatus for performing feature distillation in neural networks comprising:
means for generating a first feature map for a teacher network, the first feature map having a first channel dimension, and a second feature map for a student network, the second feature map having a second channel dimension different than the first channel dimension;
means for splitting the second feature map into segments having the first channel dimension;
first means for training the teacher network using the segments of the second feature map; and
second means for training the student network using an output of a loss function;
wherein the first and second means for training are implemented on an edge device.

14. The apparatus of claim 13, wherein the first means for training the teacher network further includes means for matching the segments of the second feature map to the first feature map.

15. The apparatus of claim 14, wherein the second means for training the student network further includes means for applying a result of the matching means to the student network.

16. The apparatus of claim 13, wherein the first means for training the teacher network further includes means for reparametrizing the teacher network based on the combination of the segments of the second feature map.

17. The apparatus of claim 13, wherein the second means for training the student network further includes means for projecting the second feature map to a pre-defined channel dimension before splitting the second feature map, the pre-defined channel dimension different than the second channel dimension.

18. The apparatus of claim 17, wherein the projecting means is a first means for projecting and the second means for training the student network further includes a second means for projecting the second feature map back to the second channel dimension after training the teacher network.

19. The apparatus of claim 13, further including means for calculating a total loss value, the total loss value corresponding to the output of the loss function.

20. A non-transitory machine readable storage medium comprising instructions that, when executed, cause processor circuitry to at least:
generate a first feature map for a teacher network based on a query, the first feature map having a first channel dimension;
generate a second feature map for a student network based on the query, the second feature map having a second channel dimension different than the first channel dimension;
split the second feature map into segments having the first channel dimension;
train the teacher network using the segments of the second feature map; and
train the student network by applying a total loss value to the student network, the total loss value based on a loss function;
wherein the teacher network and the student network are trained on an edge device simultaneously.

21-25. (canceled)
